(19) United States
(12) Patent Application Publication
(10) Pub. No.: US 2005/0226175 A1
(43) Pub. Date: Oct. 13, 2005

(54) Device, system and method for configuration of wireless access point

(76) Inventors: Ajay Gupta, Temecula, CA (US); Krishnan Rajamani, San Diego, CA (US); Jesse R. Walker, Portland, OR (US); Yigal Eliaspur, Jerusalem (IL); Alec P. Gefrides, Phoenix, AZ (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/812,388

(22) Filed: Mar. 30, 2004

(51) Int. Cl. H04B 7/00

(52) U.S. Cl. 370/310

(57) ABSTRACT

Briefly, some embodiments of the invention may provide devices, systems and methods for configuration of wireless access point. For example, a method in accordance with an embodiment of the invention may include determining whether a wireless communication station is authorized to configure a wireless access point not associated therewith based on a comparison of a first string transmitted by said wireless access point and indicating a unique identifier of said wireless access point to a second string entered at the wireless communication station.

### BACKGROUND OF THE INVENTION

In the field of wireless communications, a wireless communication system may include one or more wireless communication stations and one or more wireless access points. A station may configure a configurable access point using a wired link or a wireless link.

Configuring an access point using a wireless link may require pre-existing operative association between the access point and the configuring station, for example, in accordance with Universal Plug and Play (UPnP) standard. Furthermore, the configuration process may not be secure, for example, since the association may be performed over an insecure communication link. Additionally, in conventional systems, it is possible that a user intending to configure via a wireless link a first access point, e.g., an access point owned by the user, may instead configure a second access point, e.g., an access point owned by the user's neighbor.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system including a configurable wireless access point, and a wireless communication station able to configure the access point, in accordance with exemplary embodiments of the invention;

FIG. 2 is a schematic block diagram illustration of a wireless communication station able to configure a non-associated wireless access point in accordance with exemplary embodiments of the invention;

FIG. 3 is a schematic block diagram illustration of a configurable wireless access point in accordance with exemplary embodiments of the invention; and

FIGS. 4A-4B are a schematic flow-chart of a method of configuring a wireless access point in accordance with an enhanced configuration protocol according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), devices and/or networks operating in accordance with existing 802.11a, 802.11b, 802.11g, 802.11i, 802.11n standards and/or future versions of the above standards, a Personal Area Network (PAN), Wireless PAN (WPAN), units and/or devices which are part of the above WLAN and/or PAN and/or WPAN networks, one way and/or two-way radio communication systems, a cellular radio-telephone communication system, a cellular telephone, a wireless telephone, a Personal Communication Systems (PCS) device, a PDA device which incorporates a wireless communication device, or the like. It is noted that embodiments of the invention may be used in various other apparatuses, devices, systems and/or networks.

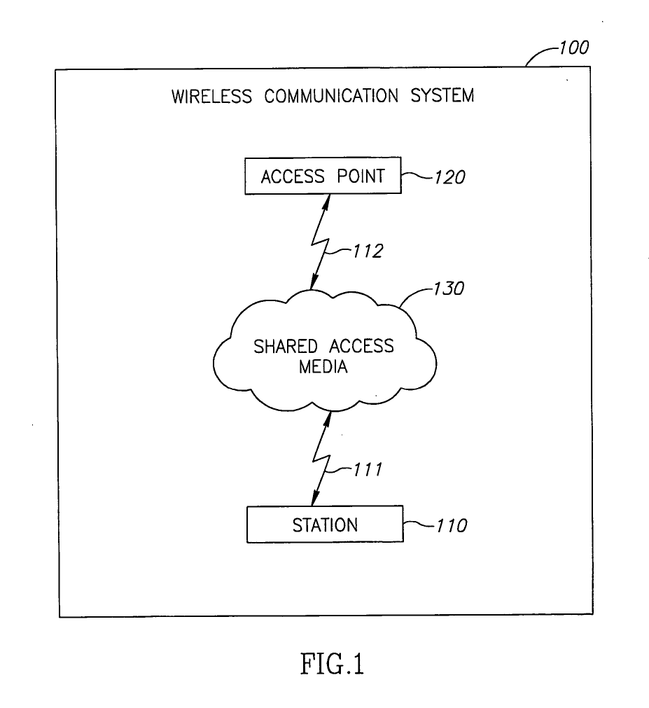

FIG. 1 schematically illustrates a block diagram of a wireless communication system 100 including a configurable wireless access point, and a wireless communication station able to configure the access point, in accordance with exemplary embodiments of the invention. System 100 may include, for example, one or more wireless communication stations, e.g., station 110, and one or more wireless access points, e.g., access point 120. Station 110 and access point 120 may communicate between themselves over a shared wireless media 130, which may include, for example, wireless communication links 111 and 112.

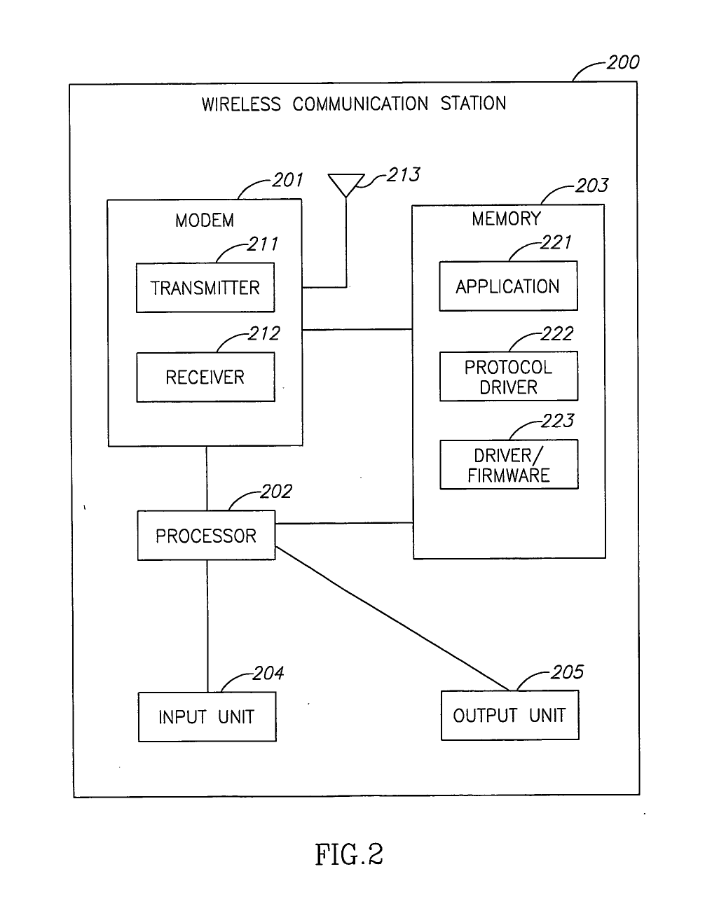

Station 110 may include, for example, a wireless communication device able to operate in accordance with one or more of the existing 802.11a standard, 802.11b standard, 802.11g standard, 802.11n standard and/or future versions of these standards, or any other suitable existing or future standards of wireless communications. In some embodiments, station 110 may include, for example, a personal computer, a desktop computer, a server computer, a mobile computer, a laptop computer, a notebook computer, a Personal Digital Assistant (PDA) device, a tablet computer, a network device, a network, an internal and/or external modem device or card, an internal and/or external fax-modem device or card, a peripheral wireless communication device, or a WLAN device. In one embodiment, station 110 may include, for example, wireless communication station 200 as described herein with reference to FIG. 2.

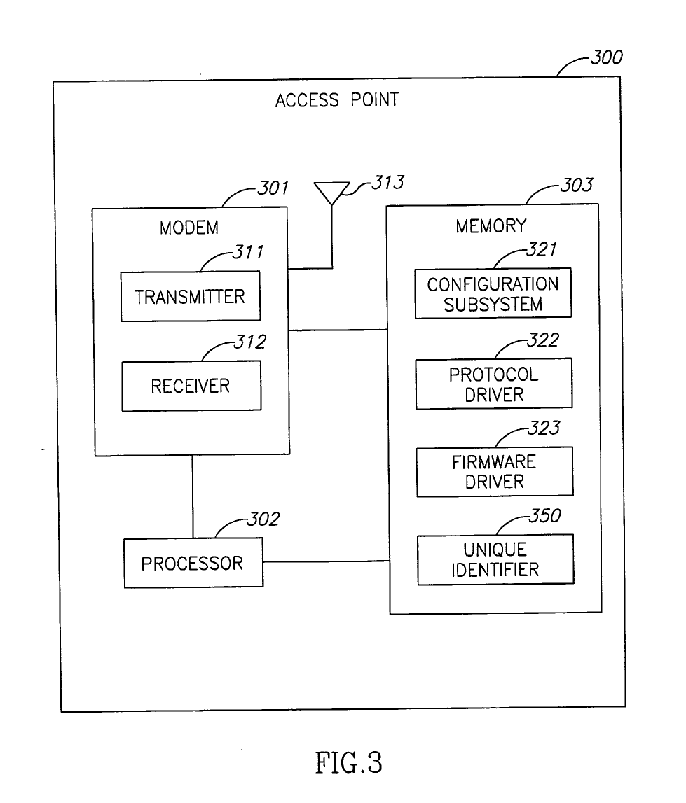

Access point 120 may include, for example, a wireless access point able to operate in accordance with one or more of the existing 802.11a standard, 802.11b standard, 802.11g standard, 802.11n standard and/or future versions of these standards, or any other suitable existing or future standards of wireless communications. In some embodiments, access point 120 may be implemented using a wireless communication station. In one embodiment, access point 120 may include, for example, access point 300 as described herein with reference to FIG. 3.

In accordance with exemplary embodiments of the invention, access point 120 may be configurable, and need not be operatively associated with station 110 in order to be configured using station 110. In one embodiment, station 110 may securely configure access point 120 as detailed herein, for example, when access point 120 is not operatively associated with station 110. For example, in some embodiments, access point 110 may transmit a string corresponding to a unique identifier of access point 120, and station 120 may receive this string and compare it to an input string entered by a user of station 110. If the comparison indicates a match, station 110 may securely configure access point 120, for example, using an encryption key. A match may verify, for example, that the user of station 110 is attempting to configure his own access point, e.g., access point 120, and not a different access point (not shown), which may be located within communication distance from station 110, e.g., a neighbor's access point. In accordance with some embodiments of the invention, the configuration may be performed before access point 120 is associated with station 110, for example, using a unique identifier of access point 120.

It is noted that station 110 and access point 120 are presented only as exemplary components of system 100 in accordance with some embodiments of the invention. Embodiments of the invention are not limited in this regard, and may be used to securely configure various other types of wireless communication stations, access points or devices. In some embodiments, for example, system 100 may include a first wireless communication station able to configure a second wireless communication station.

FIG. 2 schematically illustrates a block diagram of a wireless communication station 200 able to configure a non-associated wireless access point in accordance with exemplary embodiments of the invention. Station 200 may be an example of station 110 of FIG. 1.

Station 200 may include, for example, a modem 201, a processor 202, a memory unit 203, an input unit 204, and an output unit 205. Station 200 may further include other suitable hardware components and/or software components.

Modem 201 may include, for example, a wireless modem able to operate in accordance with one or more of the existing 802.11a standard, 802.11b standard, 802.11g standard, 802.1 In standard and/or future versions of these standards, or any other suitable existing or future standards of wireless communications. In some embodiments, modem 201 may include a transmitter 211, a receiver 212, and an antenna 213.

Transmitter 211 may include, for example, a Radio Frequency (RF) transmitter able to transmit RF signals. Receiver 212 may include, for example, a RF receiver able to receive signals RF signals. In some embodiments, transmitter 211 and receiver 212 may be implemented in the form of a transceiver, a transmitter-receiver, or one or more units able to perform separate or integrated functions of sending and/or receiving wireless communication signals, blocks, frames, packets, messages and/or data.

Antenna 213 may include an internal and/or external RF antenna. In some embodiments, for example, antenna 213 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, packets, messages and/or data.

Processor 202 may include, for example, a Central Processing Unit (CPU), a Digital Signal Processor (DSP), a microprocessor, a controller, a chip, a microchip, or any other suitable multi-purpose or specific processor or controller.

Input unit 204 may include, for example, a keyboard, a mouse, or a touch-pad, or other suitable pointing device or input device. Output unit 205 may include, for example, a Cathode Ray Tube (CRT) monitor, a Liquid Crystal Display (LCD) monitor, or other suitable monitor or display unit.

Memory unit 205 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

In some embodiments, memory unit 205 may store an application 221, which may be used to configure an access point. Application 221 may present to a user, e.g., by displaying on a monitor of output unit 205, a User Interface (UI), for example, a textual UI, or a Graphic UI (GUI). Application 221 may receive input from a user, e.g., using input unit 204. The received input may be used by station 200 to configure the access point, for example, in accordance with a pre-defined configuration protocol. The configuration protocol may be stored in memory unit 203, for example, as a protocol driver 222. Optionally, memory unit 205 or a dedicated storage unit, e.g., a driver firmware 223, may include data representing the configuration protocol. Configuration operations in accordance with the configuration protocol may be executed, for example, using processor 202 or modem 201.

FIG. 3 schematically illustrates a block diagram of a configurable wireless access point 300 in accordance with exemplary embodiments of the invention. Access point 300 may be an example of access point 120 of FIG. 1. Access point 300 need not be operatively associated with a wireless communication station.

Access point 300 may include, for example, a modem 301, a processor 302, and a memory unit 303. Access point 300 may further include other suitable hardware components and/or software components.

Modem 301 may include, for example, a wireless modem able to operate in accordance with one or more of the existing 802.11a standard, 802.11b standard, 802.11g standard, 802.11n standard and/or future versions of these standards, or any other suitable existing or future standards of wireless communications. In some embodiments, modem 301 may include a transmitter 311, a receiver 312, and an antenna 313.

Transmitter 311 may include, for example, a RF transmitter able to transmit RF signals. Receiver 312 may include, for example, a RF receiver able to receive signals RF signals. In some embodiments, transmitter 311 and receiver 312 may be implemented in the form of a transceiver, a transmitter-receiver, or one or more units able to perform separate or integrated functions of sending and/or receiving wireless communication signals, blocks, frames, packets, messages and/or data.

Antenna 313 may include an internal and/or external RF antenna. In some embodiments, for example, antenna 313 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, packets, messages and/or data.

Processor 302 may include, for example, a Central Processing Unit (CPU), a Digital Signal Processor (DSP), a microprocessor, a controller, a chip, a microchip, or any other suitable multi-purpose or specific processor or controller.

Memory unit 303 may include, for example, a Random Access Memory (RAM), a Read Only Memory (ROM), a Dynamic RAM (DRAM), a Synchronous DRAM (SD-RAM, a Flash memory, a volatile memory, a non-volatile memory, a cache memory, a buffer, a short term memory unit, a long term memory unit, or other suitable memory units or storage units.

In some embodiments, memory unit 303 may store a configuration subsystem 321, which may include, for example, an application or data used in configuring access point 300. Configuration subsystem 321 may perform configuration operations in accordance with a pre-defined configuration protocol. The configuration protocol may be stored in memory unit 303, for example, as a protocol driver 322. Optionally, memory unit 303 or a dedicated storage unit, e.g., a firmware driver 323, may include data representing the configuration protocol. Configuration operations in accordance with the configuration protocol may be executed, for example, using processor 302 or modem 301.

In some embodiments, access point 300 may be configured in accordance with a configuration protocol which may utilize a unique identifier 350. Unique identifier 350 may include, for example, a public key or a hash of a public key of access point 300 which may be used for encrypting data transmitted to access point. Unique identifier 350 may optionally include a password, a Personal Identification Number (PIN), or a pass-phrase. Unique identifier 350 may be stored in memory unit 305, for example, in a non-volatile portion or a ROM portion of memory unit 305. It is noted that unique identifier 305 may be displayed on access point 120, on a box in which access point 120 is stored, or in a document or an instructions book which may be provided to a user together with access point 120.

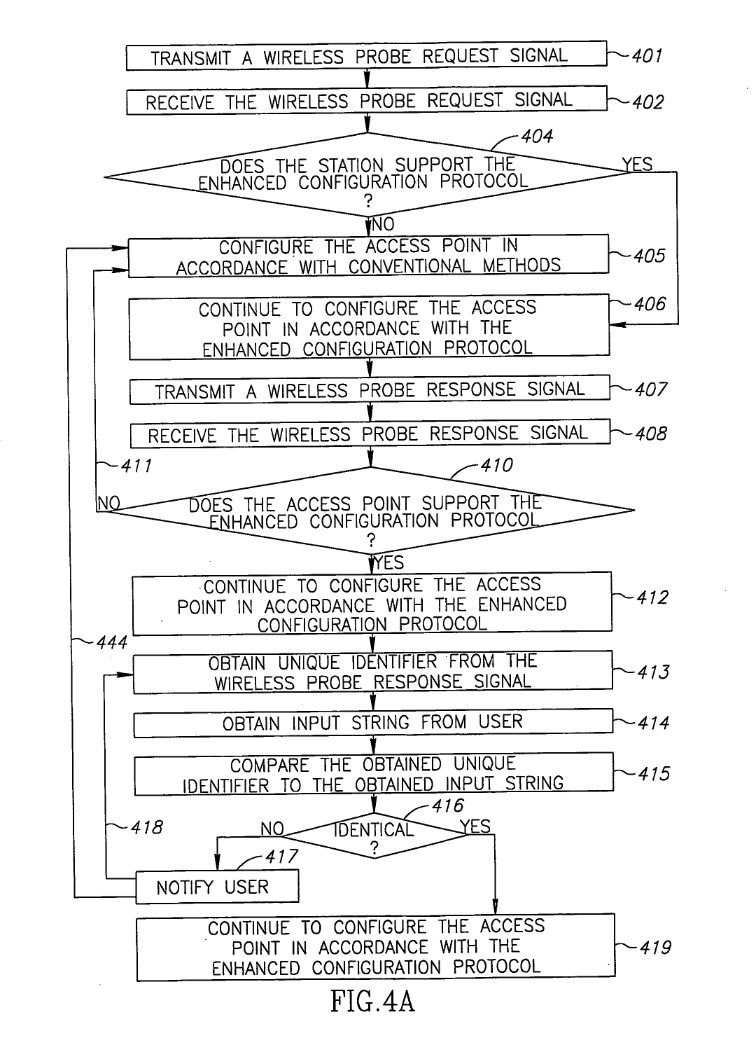

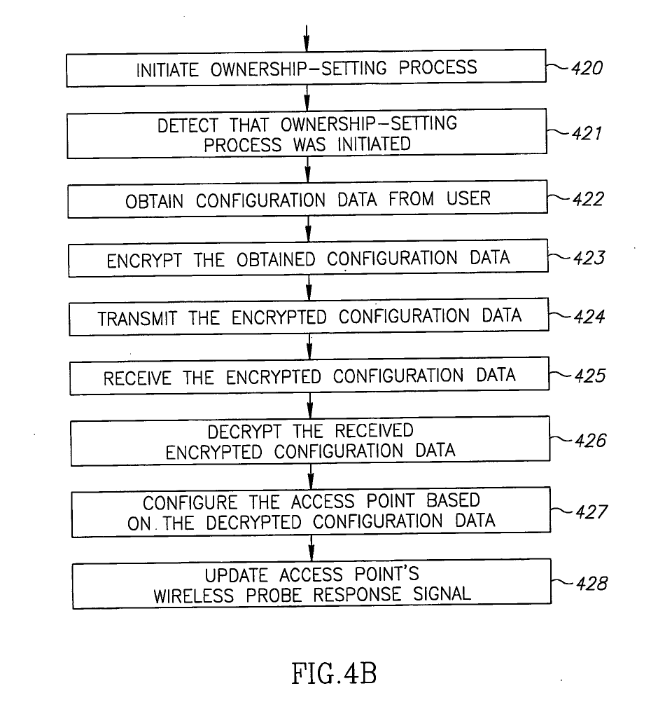

FIGS. 4A-4B are a schematic flow-chart of a method of configuring a wireless access point in accordance with an enhanced configuration protocol according to exemplary embodiments of the invention. The method may be used, for example, by station 110 to configure access point 120, or by other suitable wireless communication devices to configure other suitable wireless access points or wireless communication devices. In some embodiments, access point 120 need not be operatively associated with station 110 for using the method, and the method may be used to configure a non-associated wireless access point.

As indicated at box 401, the method may begin by transmitting a wireless probe request signal, for example, by station 110. Station 110 need not be operatively associated with a wireless access point, e.g., with access point 120. The probe request signal may include, for example, an indication that station 110 supports a certain configuration method, e.g., an enhanced configuration protocol in accordance with embodiments of the invention.

As indicated at box 402, the method may include receiving the wireless probe request signal, for example, by access point 120.

As indicated at box 404, the method may include determining by access point 120 whether or not station 110 supports the enhanced configuration protocol. This determination may be based, for example, on an analysis of the received probe request signal.

As indicated at box 405, if it is determined that station 110 does not support the enhanced configuration protocol, then the method may include configuring access point 120 in accordance with conventional methods as are known in the art.

In contrast, as indicated at box 406, if it is determined that station 110 supports the enhanced configuration protocol, then the method may include continuing to configure access point 120 in accordance with the enhanced configuration protocol. In exemplary embodiments, the enhanced configuration protocol may include performing further operations as indicated at box 407 and onward.

As indicated at box 407, the method may include transmitting a wireless probe response signal, e.g., by access point 120. In accordance with exemplary embodiments of the invention, the probe response signal may include one or more indications. One indication may include, for example, an indication that access point 120 supports the enhanced configuration protocol. Another indication may include, for example, an indication that access point 120 is not configured or fully configured, or that access point 120 is used for the first time. A further indication may include, for example, a unique identifier of access point 120, for example, unique identifier 350 of FIG. 3. The probe response signal may include any of the above indications, as well as any other suitable additional or alternative indications, flags, or data symbols.

As indicated at box 408, the method may include receiving the wireless probe response signal, for example, by station 110. As indicated at box 410, the method may include determining by station 110 whether or not access point 120 supports the enhanced configuration protocol. This determination may be based, for example, on an analysis of the received probe response signal.

As indicated at box 411, if it is determined that access point 120 does not support the enhanced configuration protocol, then the method may include configuring access point 120 in accordance with conventional methods as are known in the art. However, as indicated at box 412, if it was determined that access point 110 supports the enhanced configuration protocol, then the method may include continuing to configure access point 120 in accordance with the enhanced configuration protocol. In exemplary embodiments, the enhanced configuration protocol may include performing further operations as indicated at box 413 and onward.

As indicated at box 413, the method may further include obtaining the unique identifier from the probe response signal, for example, unique identifier 350 of access point 120. In one embodiment, unique identifier 350 may include, for example, a hash of a public key of access point 120.

As indicated at box 414, the method may include obtaining an input string from a user. In one embodiment, for example, station 110 may query the user, e.g., using output unit 205, to input the input string, e.g., using input unit 204. For example, station 110 may query the user using a display monitor to input the input string using a keyboard or a mouse. In some embodiments, the method may include requesting a user to input a string which may be displayed on access point 120, on a box in which access point 120 is stored, or in a document or an instructions book which may be provided to the user together with access point 120. In one embodiment, the input string to be typed or otherwise input by the user may include a hash of a public key of access point 120.

As indicated at box 415, the method may include comparing unique identifier 350 obtained at box 413 to the input string obtained at box 414.

As indicated at box 416, the method may perform one or more operations based on the comparison results. For example, as indicated at box 417, if the input string is not identical to unique identifier 350, then the method may include notifying the user that there is a discrepancy between the input string and the unique identifier 350. Optionally, as indicated by arrow 418, the method may include repeating one or more operations, for example, obtaining an input string from the user and comparing the input string with unique identifier 350. Optionally, if a pre-determined number of comparisons do not result in an exact match, the method may include notifying the user that the enhanced configuration protocol cannot be completed, and, as indicated by arrow 444, the method may include configuring access point 120 in accordance with conventional methods as are known in the art.

It is noted that if the input string is not identical to unique identifier 350, this may indicate that station 110 is attempting to configure an access point that does not belong to the user of station 110, e.g., an access point of a neighbor. Thus, the secure configuration process according to some embodiments of the invention may ensure that station 110 is able or authorized to configure only one or more intended access point, e.g., access point 120, and unable or unauthorized to configure any other access points, e.g., access points not authorized to or not owned by the user of station 110. Therefore, in some embodiments, the method may include determining whether station 110 is authorized to configure access point 120 not associated therewith based on a comparison of a first string transmitted by access point 120 and indicating a unique identifier of access point 120 to a second string entered at station 110.

As indicated at box 419, if the input string is identical to unique identifier 350, then the method may include continuing to configure access point 120 in accordance with the enhanced configuration protocol. In one embodiment, this may be performed, for example, by performing further operations as indicated at box 420 and onward.

As indicated at box 420, the method may proceed by initiating an ownership-setting process in accordance with a pre-determined protocol. This may be performed, for example, by station 110 using unique identifier 350. In some embodiments, the ownership-setting process may be in accordance with a pre-defined standard or protocol, for example, in accordance with a IEEE 802.1x standard, IEEE 802.11a standard, IEEE 802.11b standard, IEEE 802.11g standard, IEEE 802.16 standard, Universal Plug and Play (UpnP) standard, or Extensible Authentication Protocol (EAP).

In some embodiments, using an ownership-setting process based on EAP and/or IEEE 802.1x standard may allow further benefits than those allowed by using an ownership-setting process based on UPnP standard. For example, in some embodiments, using an ownership-setting process based on EAP and/or IEEE 802.1x standard may allow using a shorter code and/or a code having a smaller memory size or file size. Additionally or alternatively, in some embodiments, using an ownership-setting process based on EAP and/or IEEE 802.1x standard may allow to securely configure non-associated access points.

As indicated at box 421, the method may include detecting, for example, by access point 120, that an ownership-setting process was initiated. Upon such detection, as indicated at box 422, the method may include continuing and completing the ownership-setting process, for example, by access point 120. In some embodiments, the ownership-setting process may include, for example, establishing a secret encryption key or pair of encryption keys that may be used for secure communication between station 110 and access 120.

As indicated at box 422, the method may include obtaining configuration data from the user, for example, using station 110. In some embodiments, station 110 may request the user to select or otherwise input values for one or more configurable parameters, properties or variables related to wireless communications between station 110 and access point 120. For example, station 110 may prompt the user to input a Service Set Identifier (SSID) value, or a Wi-Fi Protected Access—Pre-Shared Key (WPA-PSK) value, which may be used in wireless communications between station 110 and access point 120.

As indicated at box 423, the method may include encrypting the obtained configuration data, for example, by station 110 using the established secret encryption key or pair of encryption keys. The encryption may be performed in accordance with one or more encryption algorithms as are known in the art, for example, using a Rivest Shamir Adleman (RSA) algorithm.

The method may include transmitting the encrypted configuration data, for example, by station 110, as indicated at box 424, and receiving the encrypted configuration data, for example, by access point 120, as indicated at box 425.

As indicated at box 426, the method may include decrypting the received encrypted configuration data by access point 120 using the established secret encryption key or pair of encryption keys. The decryption may be performed in accordance with one or more encryption algorithms as are known in the art, for example, the Rivest Shamir Adleman (RSA) algorithm.

As indicated at box 427, the method may include configuring access point 120 based on one or more data items included in the decrypted configuration data. This may be performed, for example, upon reception and decryption of the configuration data by access point 120. In some embodiments, for example, access point 120 may modify, set or reset a value of one or more parameters used by access point 120. In some embodiments, access point 120 may modify, write or delete a content of a memory area in access point 120 based on the configuration data. In some embodiments, access point 120 may store a SSID value or a WPA-PSK value in volatile or non-volatile memory (not shown). In some embodiments, access point 120 may modify its settings or its operation based on the configuration data.

As indicated at box 428, the method may include updating a wireless probe response signal, for example, of access point 120, to reflect that access point 120 is already configured or need not be configured. This may allow access point 120 to transmit a probe response signal indicating that access point 120 is already configured or need not be configured, for example, in response to a wireless probe request signal received by access point 120.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by station 110, by access point 120, by station 200, by modem 201, by processor 202, by modem 301, by processor 302, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 203 or memory unit 303), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C+<, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method comprising:
determining whether a wireless communication station is authorized to configure a wireless access point not associated therewith based on a comparison of a first string transmitted by said wireless access point and indicating a unique identifier of said wireless access point to a second string entered at the wireless communication station.

2. The method of claim 1, comprising transmitting a wireless probe request signal indicating that said wireless communication station supports a certain configuration protocol.

3. The method of claim 2, comprising receiving a wireless probe response signal including an indication that said wireless access point supports said certain configuration protocol, wherein said wireless probe response signal includes said first string.

4. The method of claim 3, comprising performing an ownership-setting process between said wireless communication station and said wireless access point if said first string matches said second string.

5. The method of claim 4, comprising establishing an encryption key for secure communications between said wireless access point and said wireless communication station.

6. The method of claim 5, comprising transmitting a value of a configuration parameter encrypted using said encryption key.

7. The method of claim 6, comprising decrypting by said wireless access point said encrypted transmission.

8. The method of claim 7, comprising setting a value of a parameter of said wireless access point based on the decrypted transmission.

9. The method of claim 8, wherein setting a value of a parameter comprises setting a value of at least one of a Service Set Identifier (SSID) and a Wi-Fi Protected Access—Pre-Shared Key (WPA-PSK).

10. An apparatus comprising:
a processor to determine whether a wireless communication station is authorized to configure a wireless access point not associated therewith based on a comparison of a first string transmitted by said wireless access point and indicating a unique identifier of said wireless access point to a second string entered at the wireless communication station.

11. The apparatus of claim 10, comprising a transmitter to transmit a wireless probe request signal indicating that said wireless communication station supports a certain configuration protocol.

12. The apparatus of claim 11, comprising a receiver to receive a wireless probe response signal including an indication that said wireless access point supports said certain configuration protocol, wherein said wireless probe response signal includes said first string.

13. The apparatus of claim 12, wherein said processor is able to perform an ownership-setting process between said wireless communication station and said wireless access point if said first string matches said second string.

14. The apparatus of claim 13, wherein said processor is able to establish an encryption key for secure communications between said wireless access point and said wireless communication station.

15. The apparatus of claim 14, wherein said transmitter is able to transmit a value of a configuration parameter encrypted using said encryption key.

16. A wireless communication station comprising:
a dipole antenna; and
a processor to determine whether a wireless communication station is authorized to configure a wireless access point not associated therewith based on a comparison of a first string transmitted by said wireless access point and indicating a unique identifier of said wireless access point to a second string entered at the wireless communication station.

17. The wireless communication station of claim 16, wherein said wireless communication station is able to transmit a wireless probe request signal indicating that said wireless communication station supports a certain configuration protocol.

18. The wireless communication station of claim 17, wherein said wireless communication station is able to receive a wireless probe response signal including an indication that said wireless access point supports said certain configuration protocol, wherein said wireless probe response signal includes said first string.

19. A wireless communication system comprising:
a wireless access point; and
a wireless communication station able to determine whether said wireless communication station is authorized to configure said wireless access point not associated therewith based on a comparison of a first string transmitted by said wireless access point and indicating a unique identifier of said wireless access point to a second string entered at the wireless communication station.

20. The wireless communication system of claim 19, wherein said wireless communication station is able to transmit a wireless probe request signal indicating that said wireless communication station supports a certain configuration protocol.

21. The wireless communication system of claim 20, wherein said wireless communication station is able to receive a wireless probe response signal including an indication that said wireless access point supports said certain configuration protocol, wherein said wireless probe response signal includes said first string.

22. The wireless communication system of claim 21, wherein said wireless communication station is able to perform an ownership-setting process between said wireless communication station and said wireless access point if said first string matches said second string.

23. The wireless communication system of claim 22, wherein said wireless communication station is able to establish an encryption key for secure communications between said wireless access point and said wireless communication station.

24. The wireless communication system of claim 23, wherein said wireless communication station is able to transmit a value of a configuration parameter encrypted using said encryption key.

25. The wireless communication system of claim 24, wherein said wireless access point is able to decrypt said encrypted transmission.

26. The wireless communication system of claim 25, wherein said wireless access point is able to set a value of a parameter of said wireless access point based on the decrypted transmission.

27. The wireless communication system of claim 26, wherein said value comprises a value of at least one of a Service Set Identifier (SSID) and a Wi-Fi Protected Access—Pre-Shared Key (WPA-PSK).

28. A machine-readable medium having stored thereon a set of instructions that, if executed by a machine, cause the machine to perform a method comprising:
determining whether a wireless communication station is authorized to configure a wireless access point not associated therewith based on a comparison of a first string transmitted by said wireless access point and indicating a unique identifier of said wireless access point to a second string entered at the wireless communication station.

29. The machine-readable medium of claim 28, wherein the instructions result in transmitting a wireless probe request signal indicating that said wireless communication station supports a certain configuration protocol.

30. The machine-readable medium of claim 29, wherein the instructions result in receiving a wireless probe response signal including an indication that said wireless access point supports said certain configuration protocol, wherein said wireless probe response signal includes said first string.
